(19) United States
(12) Patent Application Publication
(10) Pub. No.: US 2005/0068969 A1
(43) Pub. Date: Mar. 31, 2005

(54) Managing Internet protocol address based on dynamic host configuration protocol

(76) Inventors: Ji-Hyun Park, Seoul (KR); Young-Mi Son, Suwon-si (KR); Ho-Chul Shin, Suwon-si (KR); Young-Jip Kim, Suwon-si (KR)

Correspondence Address: Robert E. Bushnell;Suite 300, 1522 K Street, N.W., Washington, DC, 20005, US

(21) Appl. No.: 10/919,459

(22) Filed: Aug. 17, 2004

(30) Foreign Application Priority Data
Sep. 25, 2003 (KR) 2003-66651

(51) Int. Cl. H04L 12/66

(52) U.S. Cl. 370/400; 370/352; 709/217

(57) ABSTRACT

Internet Protocol (IP) addresses are generated based on a Dynamic Host Configuration Protocol (DHCP) to manage an Internet Protocol address and an identifier (ID) of a network unit seeking access to a network using the Dynamic Host Configuration Protocol to allow the network unit to have easy access to an external server providing a variety of services (e.g., a home network service). A Dynamic Host Configuration Protocol server is adapted to dynamically assign the Internet Protocol address when the network unit seeks access to the network, the network unit being connected to an external Internet network using the Internet Protocol address assigned dynamically from the Dynamic Host Configuration Protocol server. A network unit management server is adapted to manage information on the Internet Protocol address assigned by the Dynamic Host Configuration Protocol server and the identifier of the network unit corresponding to the Internet Protocol address. A service provider server is adapted to receive a service request of a subscriber to transmit a service processing result of the service request to the corresponding network unit managed by the network unit management server.

### CLAIM OF PRIORITY

This application makes reference to, incorporates the same herein, and claims all benefits accruing under 35 U.S.C. § 119 from an application for APPARATUS AND METHOD FOR MANAGING INTERNET PROTOCOL ADDRESS BASED ON DYNAMIC HOST CONFIGURATION PROTOCOL earlier filed in the Korean Intellectual Property Office on 25 Sep. 2003 and there duly assigned Ser. No. 2003-66651.

### BACKGROUND OF THE INVENTION

1. Field of the Invention

The present invention relates to an Internet Protocol (IP) based home network service and, more particularly, to managing an IP address based on a Dynamic Host Configuration Protocol (DHCP), designed to actively manage an IP address and an identifier (ID) of a network unit gaining access to a network using the DHCP to have easy access to an external server providing a variety of services (e.g., a home network service).

2. Description of the Related Art

With the advent of the home network age, detailed rules for realizing the home network have been established. There is an expectation that a digital television will be unquestionably placed at the center of the system for realizing such a home network. This expectation results from the fact that the personal computer, as a leader of an information-oriented society up to now, would be an information household appliance which a person uses and enjoys by oneself, while the television would be a household appliance which all the family can use with ease.

The digital television, which will play the leading role in the home network in the future, makes it possible to transmit information in both directions, thus enabling a television viewer to select and utilize information beyond simply seeing and hearing.

Further, the digital television will function as a home master to interconnect and control digital household appliances such as a Digital Versatile Disk (DVD), an audio system, a refrigerator, a washing machine, etc., over the network.

This home network will be expected to provide a service on a wire using an existing telephone line and a cable modem and through a wireless terminal such as a laptop, a Personal Digital Assistant (PDA), a Wireless Datagram Protocol (WDP), a Personal Communication Service (PCS), etc.

A set-top box is a practical apparatus which enables a digital television to effect bi-directional information transmission over the Internet.

The set-top box turns the digital television into an Internet user interface. Actually, the set-top box, as a special computer capable of transceiving data over the Internet, provides a web browser and a protocol, such as TCP/IP, for example.

Various services providing the home network are based on the IP, but there are various difficulties in smoothly performing these services in an IP address assignment method using the current DHCP.

At present, there is a Domain Name System (DNS) service, which makes it possible to provide the IP based services. The DNS service only provides a function of translating a user's fixed IP (or dynamic) IP into a domain name capable of having outside access.

However, these DNS services are only supported as an auxiliary service for serving a Hyper Text Transfer Protocol (HTTP), a File Transfer Protocol (FTP), e-mail etc., all of which already existing.

Further, most DNS services adopt a mode in which a periodic determination is made as to whether or not the IP address has changed, and if the IP address has changed, the previous IP address and domain name are updated by the DNS server.

This periodic IP address checking method can possibly prevent a valid subscriber from obtaining service, because it is impossible to update an IP address which has been changed within the checking period.

Further, because there is no registration and management function for users getting specified services, and because it is difficult for the ISP to know details as to the users' situation, whether or not the services are provided, etc., there is a problem in that it is impossible to efficiently and actively cope with the home network and various services which are to be provided in the future.

The following patents each discloses features in common with the present invention but do not teach or suggest the inventive features specifically recited in the present application: U.S. patent application Ser. No. 2003/0185233 to Ji et al., entitled METHOD, APPARATUS, AND MEDIUM FOR MIGRATION A CROSS LINK TECHNOLOGIES, published on Oct. 2, 2003; U.S. patent application Ser. No. 2004/0017818 to Chung, entitled NETWORK ADDRESS CONVERSION SYSTEM AND THE METHOD THEREOF, published on Jan. 29, 2004; U.S. patent application Ser. No. 2004/0071149 to Kim et al., entitled METHOD AND APPARATUS FOR TRANSMITTING DTA IN A SYSTEM USING NETWORK ADDRESS TRANSLATION, published on Apr. 15, 2004; U.S. patent application Ser. No. 2004/0037316 to Choi et al., entitled APPARATUS FOR CONVERTING INTERNET PROTOCOL ADDRESS AND HOME NETWORK SYSTEM USING THE SAME, published on Feb. 26, 2004; U.S. patent application Ser. No. 2004/0045031 to Gautier, entitled AUTOMATIC IDENTIFICATION OF A SET-TOP BOX USER TO A NETWORK, published on Mar. 4, 2004; U.S. patent application Ser. No. 2004/0052216 to Roh, entitled INTERNET PROTOCOL ADDRESS ALLOCATION DEVICE AND METHOD, published on Mar. 18, 2004; U.S. patent application Ser. No. 20040064520 to Takahashi et al., entitled NETWORK IDENTIFICATION INFORMATION AUTOMATIC MANAGEMENT SYSTEM AND METHOD, published on Apr. 1, 2004; U.S. patent application Ser. No. 20040064559 to Kupst et al., entitled METHOD AND APPARATUS FOR DYNAMIC ASSIGNMENT OF NETWORK PROTOCOL ADDRESSES, published on Apr. 1, 2004; U.S. patent application Ser. No. 2001/0023459 to Asami, entitled DNS SERVER, DHCP SERVER, TERMINAL AND COMMUNICATION SYSTEM, published on Sep. 20, 2001; and U.S. patent application Ser. No. 2002/0024959 to Kong, entitled NETWORK ADDRESS CONVERSION SYSTEM FOR ENABLING ACCESS TO A NODE HAVING A PRIVATE IP ADDRESS, A METHOD THEREFOR, AND A RECORDING MEDIUM FOR RECORDING THE METHOD, published on Feb. 28, 2002.

### SUMMARY OF THE INVENTION

It is, therefore, an object of the present invention is to actively manage an identifier and an Internet Protocol address of a network unit (e.g., a set-top box, a home gateway, etc.) so as to smoothly provide various home network services, such as Video on Demand (VOD), an order-delivery service, a messenger service and so forth including a Hyper Text Transfer Protocol (HTTP), a File Transfer Protocol (FTP), e-mail, etc.

In order to accomplish this object, according to one aspect of the present invention, an apparatus is provided comprising: a Dynamic Host Configuration Protocol server adapted to dynamically assign an Internet Protocol address upon a network unit seeking access to a network, the network unit being connected to an external Internet network using the Internet Protocol address dynamically assigned by the Dynamic Host Configuration Protocol server; a network unit management server adapted to manage information on the Internet Protocol address assigned by the Dynamic Host Configuration Protocol server and on an identifier of the network unit corresponding to the Internet Protocol address; and a service provider server adapted to receive a service request of a subscriber and to transmit a service processing result of the service request to the corresponding network unit managed by the network unit management server.

Preferably, the network unit management server is adapted to store a message communication protocol and to maintain a session using the network unit and a Transmission Control Protocol socket to transmit and receive messaging data.

Preferably, the network unit management server is adapted to directly manage a database of the identifier and the Internet Protocol address of the network unit.

Preferably, the network unit management server is adapted to directly manage a database of the identifier and the Internet Protocol address of the network unit.

Preferably, the network unit comprises one of a set-top box, a home gateway and a wireless Local Area Network Access Point.

Preferably, the identifier of the network unit comprises a Media Access Control address.

Preferably, the network unit is connected to a home network system and is adapted to perform monitoring and remote control of at least one appliance.

Preferably, the network unit comprises a network interface unit adapted to drive a Dynamic Host Configuration Protocol client to be assigned the IP address by the Dynamic Host Configuration Protocol server, and an address synchronization unit adapted to drive a message client to transmit both the identifier of the address synchronization unit and the assigned IP address of the network interface unit to the network unit management server.

Preferably, the network unit is adapted to drive the Dynamic Host Configuration Protocol client to be assigned the IP address by the Dynamic Host Configuration Protocol server, to drive the message client to transmit both the identifier of the network unit and the assigned IP address of the network interface unit to the network unit management server, and to provide a user interface.

Preferably, the service provider server is adapted to receive information on a current Internet Protocol address of the network unit seeking access through the network unit management server and to have access to the network unit to provide a service.

In order to accomplish this object, according to another aspect of the present invention, a method is provided comprising: driving a Dynamic Host Configuration Protocol client to assign an Internet Protocol address the network unit; transmitting the assigned Internet Protocol address from a Dynamic Host Configuration Protocol server to the network unit; storing a Dynamic Host Configuration Protocol Internet Protocol address in a predetermined file of the network unit; transmitting the assigned Dynamic Host Configuration Protocol Internet Protocol address and an identifier of the network unit from the network unit to a network unit management server; and updating information on the Dynamic Host Configuration Protocol Internet Protocol address and the identifier of the network unit in the network unit management server.

Preferably, the method further comprises reassigning the Internet Protocol address assigned by the Dynamic Host Configuration Protocol server upon a link of the network unit being disconnected and then connected again.

Preferably, the identifier of the network unit comprises a Media Access Control address.

In order to accomplish this object, according to yet another aspect of the present invention, a program storage device, readable by a machine, tangibly embodying a program of instructions executable by the machine to perform a method of managing an Internet Protocol address based on a Dynamic Host Configuration Protocol is provided, the method comprising: driving a Dynamic Host Configuration Protocol client to assign an Internet Protocol address the network unit; transmitting the assigned Internet Protocol address from a Dynamic Host Configuration Protocol server to the network unit; storing a Dynamic Host Configuration Protocol Internet Protocol address in a predetermined file of the network unit; transmitting the assigned Dynamic Host Configuration Protocol Internet Protocol address and an identifier of the network unit from the network unit to a network unit management server; and updating information on the Dynamic Host Configuration Protocol Internet Protocol address and the identifier of the network unit in the network unit management server.

Preferably, the method further comprises reassigning the Internet Protocol address assigned by the Dynamic Host Configuration Protocol server upon a link of the network unit being disconnected and then connected again.

Preferably, the identifier of the network unit comprises a Media Access Control address.

### BRIEF DESCRIPTION OF THE DRAWINGS

A more complete appreciation of the present invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view of a general DNS (Domain Name System) service system;

FIG. 2 is a view of an IP address management system for providing a home network service based on a Dynamic Host Configuration Protocol (DHCP) according to an embodiment of the present invention;

FIG. 3 is a flowchart of a method of providing a home network service based on a Dynamic Host Configuration Protocol (DHCP) according to an embodiment of the present invention;

FIG. 4 is a view of an IP address management system, when the network unit of FIG. 2 is a set-top box; and

FIG. 5 is a flowchart of a method of providing a home network service, if a network unit management server is operated separately from a database server.

### DETAILED DESCRIPTION OF THE INVENTION

The following is a description of a general DNS service system.

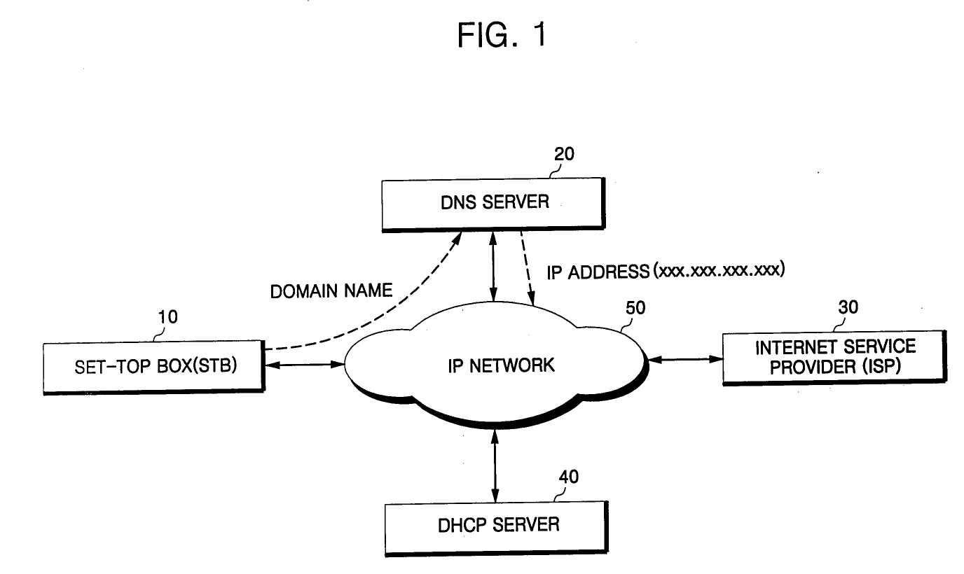

Referring to FIG. 1, a system associated with the DNS service comprises a set-top box 10, a DNS server 20, an Internet Service Provider (ISP) 30, a DHCP server 40 and an IP network 50. The set-top box 10 provides an Internet interface and an Internet Protocol. The DNS server 20 provides a service of translating a domain name into an IP address. The DHCP server 40 manages and assigns the IP address, and functions to automatically send a new IP address when a computer is re-booted.

The set-top box 10 is booted upon being turned on. When booting has been completed, the IP address is assigned from the DHCP server 40. The assigned IP address is managed by the DNS server 20. If a new IP address is assigned later on, the previous IP address is updated to the new IP address in a database (not shown) of the DHCP server 40.

The DNS server 20 enables users to have easy access to the ISP 30 only using their domain name.

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. In the drawings, the thickness of layers and regions are exaggerated for clarity. Like numbers refer to like elements throughout the specification.

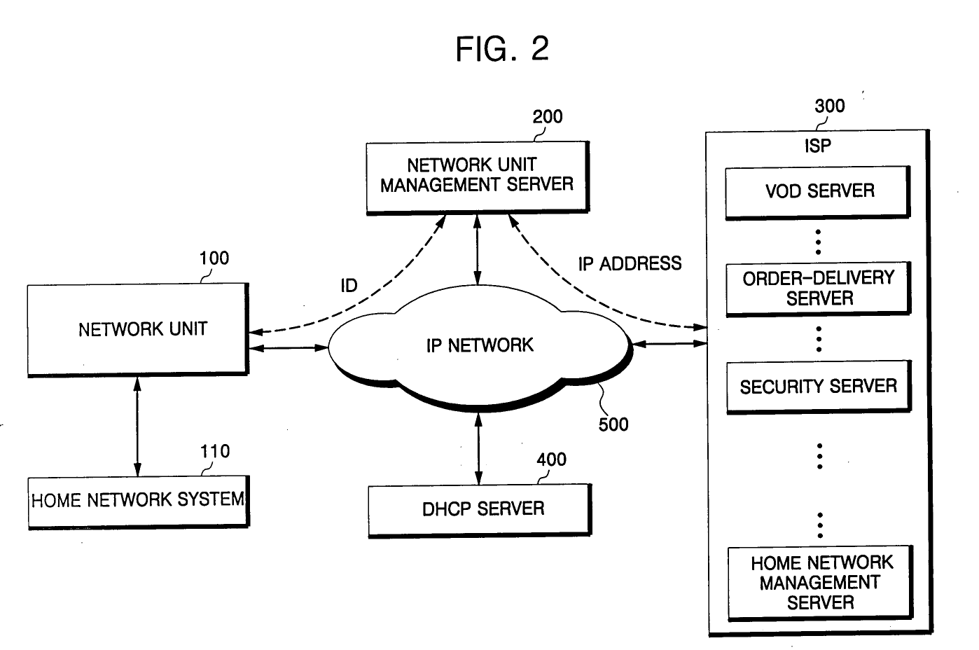

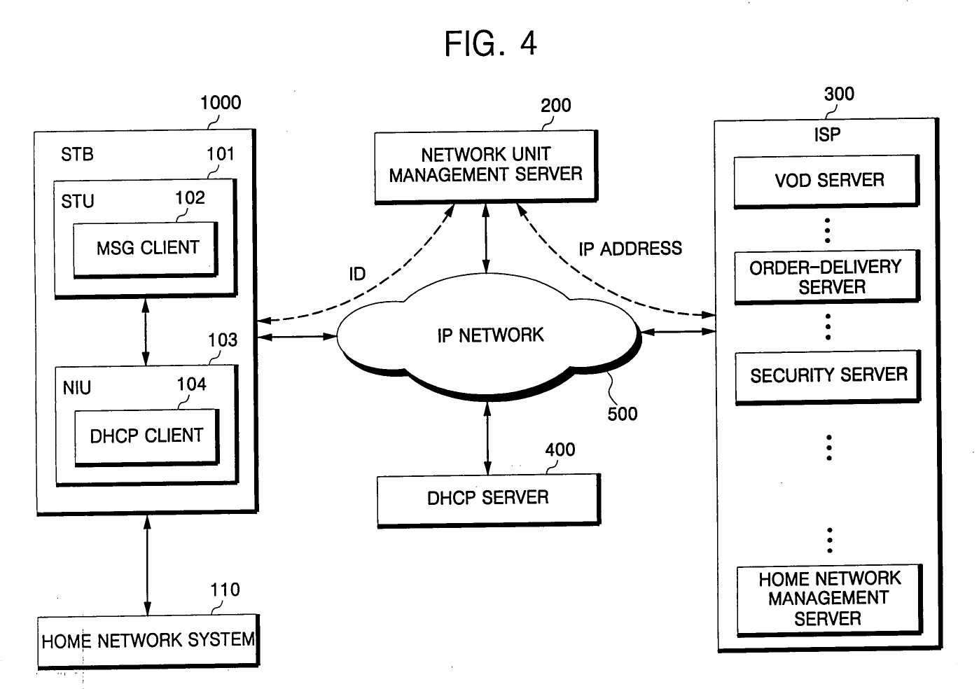

FIG. 2 is a view of an IP address management system for providing a home network service based on a Dynamic Host Configuration Protocol (DHCP) in accordance with one embodiment of the present invention, and FIG. 4 is a view of an IP address management system when the network unit 100 of FIG. 2 is a set-top box 1000.

Referring to FIG. 2, a configuration of the IP address management system for providing the home network service to a home network system 110 includes a network unit 100, a network unit management server 200, an Internet Service Provider (ISP) 300, a DHCP server 400 and an IP network 500.

The network unit 100 causes the DHCP server 400 to assign an IP address to a DHCP client and causes a message (Msg) client to transmit both an identifier (ID) (Media Access Control (MAC) address) of the network unit 100 itself and the IP address assigned by the DHCP server 400 to the network unit management server 200, thus providing user interfaces for users.

The network unit 100 can include a set-top box, a home gateway (Home G/W), or a wireless LAN (Local Access Network) Access Point (AP), for example.

The network unit management server 200 has a database for an IP table which corresponds to the ID of the network unit 100 and the IP address assigned to the network unit 100, and manages information on both the IP address assigned from the DHCP server 400 and the ID of the network unit 100 in accordance with the database. Further, the network unit management server 200 acts as a gateway to receive and distinguish specific service request messages of the users and to transmit the messages to a server for the corresponding service.

The ISP 300 has at least one server to receive information on a present IP address of the network unit 100 seeking to have access through the network unit management server 200 and then to have access to the network unit 100 to provide the service.

Referring to FIG. 4, the set-top box 1000 can be connected to a home network system 110 to perform a remote control and a monitoring service with respect to security/fire of various household appliances within the home.

The set-top box 1000 is constituted of a Network Interface Unit (NIU) 103 for driving a DHCP client 104 to be assigned an IP address from the DHCP server 400, and a Set-Top Unit (STU) for causing a message (Msg) client 102 to transmit both an identifier (ID) of the set-top box 1000 and the IP address assigned by the DHCP server 400 to the network unit management server 200 and thereby perform address synchronization.

The NIU 103 and the STU 102 can be configured as a single unit.

The STU 101 causes the message (Msg) client 102 to transmit both an ID of the STU and the IP address assigned the NIU 103 by the DHCP server 400 to the network unit management server 200.

The network unit management server 200 contains a database consisting of the ID of the set-top box 1000 and an IP table corresponding to the IP address assigned to the set-top box 1000. The IP table can be in the format of Table 1.

TABLE 1

| Set-top box ID | IP address |
|---|---|
| 08-00-20-80-DE-62 | 211.2XX.169.0 |
| . . . | . . . |
| 01-00-5E-00-00-05 | 255.255.XXX.XXX |
| FF-FF-FF-FF-FF-FF | 255.255.255.255 |

Then, when the set-top box 1000 is re-linked and reassigned the IP address, the previous IP table is updated with the changed IP address.

The network unit management server 200 manages the ID and the IP address of the set-top box 1000, and at the same time, as a gateway of all services, transmits messages of the requested services to the users. In other words, the network unit management server 200 acts as the gateway to receive and distinguish specific service request messages of the users and to transmit the messages to a server for the corresponding service

When the number of set-top boxes 1000 to be managed are increased due to an increase in the number of subscribers, it is preferable to arrange a separate database (DB) server rather than to manage the ID and the IP address of the set-top box 1000 at the network unit management server 200.

In the case of managing the separate DB server, when a user logs on, the DB server manages the ID and the IP address of the set-top box 1000 that have been transmitted from the network unit management server 200, and simultaneously performs a user authentication request from the server of the ISP, thus monitoring the services provided according to the user.

If the subscriber (user) requests a desired service to a Video On Demand (VOD) server of the ISP 300 using the set-top box 1000, the ID of the set-top box 1000 is searched in the DB of the network unit management server 200 or in the IP table of the DB server, and the result is then transmitted to the set-top box 1000.

As shown, the ISP 300 includes a VOD server, an order-delivery server, a security server and a home network management server, but these elements can vary according to the type of service needed by the user.

A description follows as to how the services are practically provided in the case of the user wanting to get the home network and various services.

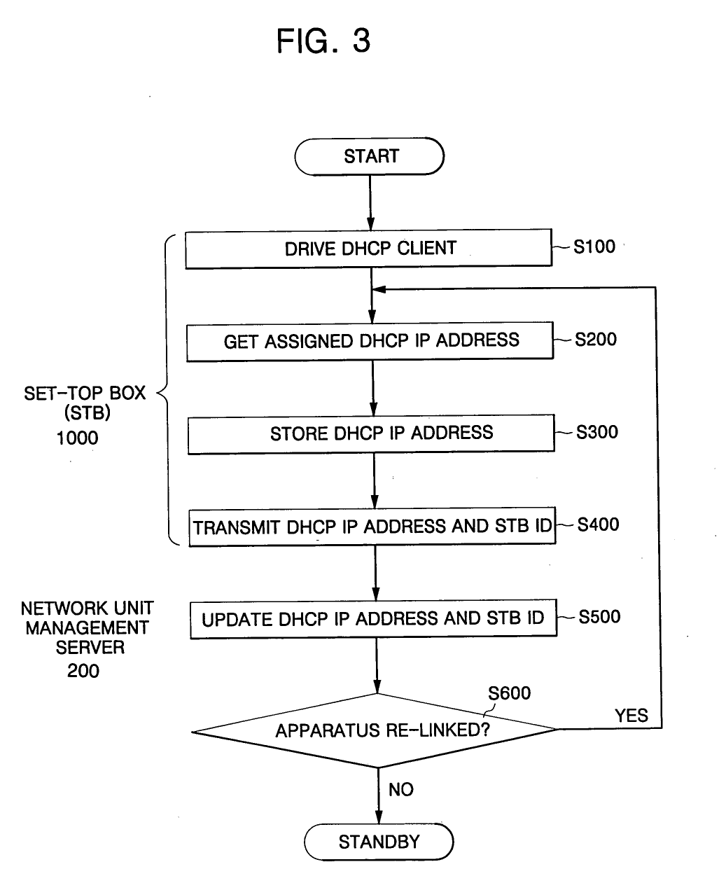

FIG. 3 is a flowchart of a method of providing home network services based on a DHCP in accordance with an embodiment of the present invention.

First, when the user turns on the set-top box 1000 in order to use the services, the set-top box 1000 is booted. As a result, the set-top box 1000 drives the DHCP client (S100).

As the DHCP client is driven, the DHCP client is assigned an IP address broadcast from the DHCP server 400 (S200).

The set-top box 1000 stores the assigned IP address in a predetermined file (S300), and transmits an ID (MAC address) of the set-top box 1000 and the currently assigned IP address to the network unit management server 200 (S400).

The network unit management server 200 receives the ID and the IP address of the set-top box 1000 and updates the DHCP IP address and the ID of the set-top box 1000 in the IP table of the DB (S500).

If the IP address and the ID of the STB 1000 are stored in the IP table of the network unit management server 200, when the user transmits a service request signal to a server of the ISP 300, the server of the ISP 300 transmits the requested service to a current IP address corresponding to the ID of the STB 1000.

When the set-top box 1000 is re-booted due to a turning off of the set-top box, etc. (S600), the process returns to step S200, i.e., the step where the DHCP IP address is assigned. Therefore, the IP table of the network unit management server 200 is updated from the present ID of the STB 1000 to the assigned new IP address, so that the user is able to continuously receive the service.

The method of providing home network services based on a DHCP described with reference to FIG. 3 is directed to the case of directly managing the ID and the IP address of the STB 1000 at the network unit management server 200.

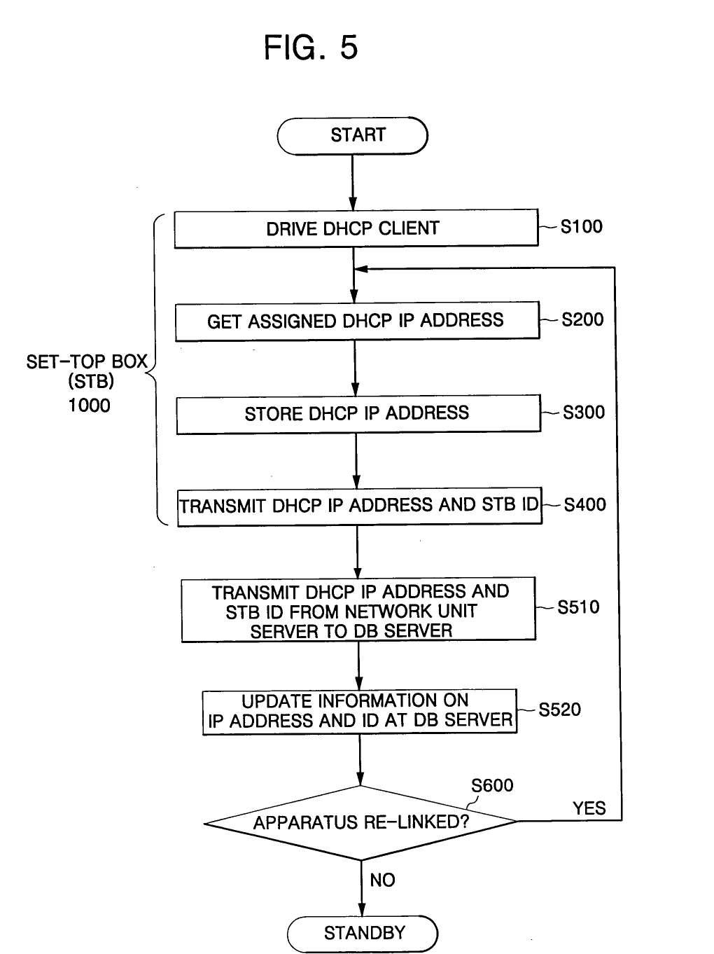

Hereinafter, the case of directly managing the ID and the IP address of the STB 1000 at the DB server with the network unit management server 200 separated from the DB server is described below with reference to FIG. 5.

FIG. 5 is a flowchart of a method of providing home network services, in which a network unit management server is operated separately from a DB server.

Procedures(S100˜S400) in which a DHCP IP address is assigned to the STB 1000 and the assigned DHCP IP address is transmitted to the network unit management server 200 are similar to those of FIG. 3. For this reason, their descriptions have been omitted.

The network unit management server 200 receives the ID and the IP address of the STB 1000 and transmits the DHCP IP address and the ID of the STB 1000 to the DB server (S5 10).

The DB server updates information on the received DHCP IP address and the ID of the STB 1000 (S520).

When the STB 1000 is re-booted due to a turning off of the set-top box 1000, etc. (S600), the process returns to step S200, i.e., the step where the DHCP IP address is assigned. Therefore, the IP table of the DB server is updated from the present ID of the STB 1000 to the assigned new IP address so that the user is able to continuously receive the service.

The present invention has been described using the set-top box as an example of the network unit. However, the same method can be used to manage the IP address when the network unit is a home gateway or a wireless LAN AP.

As can be seen from the foregoing, although an exemplary embodiment of the present invention has been described in detail, those skilled in the art will appreciate that various modifications, additions and substitutions are possible, without departing from the scope and spirit of the present invention as recited in the accompanying claims.

As mentioned above, according to the present invention, the ID and the IP address of the network unit is immediately synchronized. Thus, when a network unit, such as a set-top box, is arranged in the home with the dynamic DHCP network maintained as is, a variety of additional services (e.g., the home network service, etc.) can be provided in a reliable and constant manner.

Further, the ID and the IP address of the network unit are managed under the control of the ISP, so that authentication and management of the user can be effectively performed.

1. An apparatus comprising:
a Dynamic Host Configuration Protocol server adapted to dynamically assign an Internet Protocol address upon a network unit seeking access to a network, the network unit being connected to an external Internet network using the Internet Protocol address dynamically assigned by the Dynamic Host Configuration Protocol server;
a network unit management server adapted to manage information on the Internet Protocol address assigned by the Dynamic Host Configuration Protocol server and on an identifier of the network unit corresponding to the Internet Protocol address; and
a service provider server adapted to receive a service request of a subscriber and to transmit a service processing result of the service request to the corresponding network unit managed by the network unit management server.

2. The apparatus as claimed in claim 1, wherein the network unit management server is adapted to store a message communication protocol and to maintain a session using the network unit and a Transmission Control Protocol socket to transmit and receive messaging data.

3. The apparatus as claimed in claim 1, wherein the network unit management server is adapted to directly manage a database of the identifier and the Internet Protocol address of the network unit.

4. The apparatus as claimed in claim 2, wherein the network unit management server is adapted to directly manage a database of the identifier and the Internet Protocol address of the network unit.

5. The apparatus as claimed in claim 1, wherein the network unit comprises one of a set-top box, a home gateway and a wireless Local Area Network Access Point.

6. The apparatus as claimed in claim 1, wherein the identifier of the network unit comprises a Media Access Control address.

7. The apparatus as claimed in claim 1, wherein the network unit is connected to a home network system and is adapted to perform monitoring and remote control of at least one appliance.

8. The apparatus as claimed in claim 1, wherein the network unit comprises a network interface unit adapted to drive a Dynamic Host Configuration Protocol client to be assigned the IP address by the Dynamic Host Configuration Protocol server, and an address synchronization unit adapted to drive a message client to transmit both the identifier of the address synchronization unit and the assigned IP address of the network interface unit to the network unit management server.

9. The apparatus as claimed in claim 1, wherein the network unit is adapted to drive the Dynamic Host Configuration Protocol client to be assigned the IP address by the Dynamic Host Configuration Protocol server, to drive the message client to transmit both the identifier of the network unit and the assigned IP address of the network interface unit to the network unit management server, and to provide a user interface.

10. The apparatus as claimed in claim 1, wherein the service provider server is adapted to receive information on a current Internet Protocol address of the network unit seeking access through the network unit management server and to have access to the network unit to provide a service.

11. A method comprising:
driving a Dynamic Host Configuration Protocol client to assign an Internet Protocol address the network unit;
transmitting the assigned Internet Protocol address from a Dynamic Host Configuration Protocol server to the network unit;
storing a Dynamic Host Configuration Protocol Internet Protocol address in a predetermined file of the network unit;
transmitting the assigned Dynamic Host Configuration Protocol Internet Protocol address and an identifier of the network unit from the network unit to a network unit management server; and
updating information on the Dynamic Host Configuration Protocol Internet Protocol address and the identifier of the network unit in the network unit management server.

12. The method as claimed in claim 11, further comprising reassigning the Internet Protocol address assigned by the Dynamic Host Configuration Protocol server upon a link of the network unit being disconnected and then connected again.

13. The method as claimed in claim 11, wherein the identifier of the network unit comprises a Media Access Control address.

14. A program storage device, readable by a machine, tangibly embodying a program of instructions executable by the machine to perform a method of managing an Internet Protocol address based on a Dynamic Host Configuration Protocol, the method comprising:
driving a Dynamic Host Configuration Protocol client to assign an Internet Protocol address the network unit;
transmitting the assigned Internet Protocol address from a Dynamic Host Configuration Protocol server to the network unit;
storing a Dynamic Host Configuration Protocol Internet Protocol address in a predetermined file of the network unit;
transmitting the assigned Dynamic Host Configuration Protocol Internet Protocol address and an identifier of the network unit from the network unit to a network unit management server; and
updating information on the Dynamic Host Configuration Protocol Internet Protocol address and the identifier of the network unit in the network unit management server.

15. The program storage device as claimed in claim 14, the method further comprising reassigning the Internet Protocol address assigned by the Dynamic Host Configuration Protocol server upon a link of the network unit being disconnected and then connected again.

16. The program storage device as claimed in claim 11, wherein the identifier of the network unit comprises a Media Access Control address.
